(19) United States
(12) Patent Application Publication
(10) Pub. No.: US 2026/0119812 A1
(43) Pub. Date: Apr. 30, 2026

(54) SYSTEM FOR EVALUATING A LARGE LANGUAGE MODEL GENERATED RESPONSE TO A USER QUERY

(71) Applicant: Capital One Services, LLC., McLean, VA (US)

(72) Inventors: Grace LEAKE, Plano, TX (US); Rahul SHAH, Plano, TX (US); Brooke SLEZAK, Addison, TX (US)

(21) Appl. No.: 18/931,808

(22) Filed: Oct. 30, 2024

(51) Int. Cl. G06F 40/40; G06N 5/01

(52) U.S. Cl. CPC G06F 40/40; G06N 5/01

(57) ABSTRACT

In some implementations, a system may obtain a user query. The system may generate a response to the user query using a large language model (LLM), wherein the LLM generates the response based on a first persona. The system may evaluate the response using the LLM, wherein the LLM evaluates the response based on a second persona that is different from the first persona. The system may perform a response evaluation action based on a result of evaluating the response.

### BACKGROUND

A large language model (LLM) is a type of artificial intelligence (AI) model designed to understand and generate a human-like output based on a large amount of language data. In general, an LLM may be trained on extensive datasets and may have many (e.g., billions) of parameters that enable the LLM to perform various language-related tasks, such as text generation (e.g., writing essays, stories, articles, code, or the like), language translation (e.g., converting text from one language to another), summarization (e.g., condensing text into a concise summary), question response (e.g., responding to a question with a relevant answer), or sentiment analysis (e.g., detecting a sentiment or mood within text), among other examples. As LLMs are used for an increasing number and variety of tasks, ensuring that outputs of LLMs are of sufficient quality (e.g., relevant and accurate) is important.

### SUMMARY

In some implementations, a system for evaluating a large language model (LLM) generated response to a user query includes one or more memories; and one or more processors, communicatively coupled to the one or more memories, configured to: obtain the user query; generate a response to the user query based on a first prompt and using an LLM, wherein the first prompt causes the LLM to generate the response based on a first persona; evaluate the response based on a second prompt and using the LLM, wherein the second prompt causes the LLM to evaluate the response based on a second persona that is different from the first persona; and perform a response evaluation action based on a result of evaluating the response.

In some implementations, a method for evaluating an LLM-generated response to a user query includes obtaining, by a system, a user query; generating, by the system, a response to the user query using an LLM, wherein the LLM generates the response based on a first persona; evaluating, by the system, the response using the LLM, wherein the LLM evaluates the response based on a second persona that is different from the first persona; and performing, by the system, a response evaluation action based on a result of evaluating the response.

In some implementations, a non-transitory computer-readable medium storing a set of instructions includes one or more instructions that, when executed by one or more processors of a system, cause the system to: obtain a query provided via user input; obtain, as a first output of an LLM, a response to the query, wherein the LLM is instructed to generate the first output based on adopting a first persona; obtain, as a second output of the LLM, a result associated with an evaluation of the response, wherein the LLM is instructed to evaluate the response based on adopting a second persona that is different from the first persona; and perform a response evaluation action based on the result of the evaluation of the response.

### BRIEF DESCRIPTION OF THE DRAWINGS

FIGS. 1A-1C are diagrams of an example related to evaluating an LLM-generated response to a user query, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with evaluating an LLM-generated response to a user query, in accordance with some embodiments of the present disclosure.

FIG. 4 is a flowchart of an example process associated with evaluating an LLM-generated response to a user query, in accordance with some embodiments of the present disclosure.

### DETAILED DESCRIPTION

The following detailed description of example implementations refers to the accompanying drawings. The same reference numbers in different drawings may identify the same or similar elements.

An LLM may be trained to receive a user query and generate an output in the form of a response to the user query. An inherent risk of the use of an LLM model is that an LLM-generated response provided by the LLM model may in some cases include inappropriate, irrelevant, or hallucinated information, meaning that quality assurance of LLM-generated responses is needed. Conventionally, quality assurance of such LLM-generated responses is performed manually (e.g., by a human). However, performing quality assurance manually results in inconsistency with respect to response review (e.g., when different humans review LLM-generated responses) and latency with respect to providing responses to users (e.g., when quality assurance review is performed prior to a response being provided to a user).

Further, evaluating LLM-generated responses in a non-manual fashion (i.e., without humans) is challenging. Reference-based metrics that compare an LLM-generated response to a defined source of truth and reference-free metrics that evaluate standalone LLM-generated responses have been used in some scenarios. However, such metrics have been shown to have a low correlation with human judgment and, therefore, may be unreliable. This disparity is particularly significant when evaluating LLM-generated responses associated with open-ended LLM tasks, such as dialogue response generation.

Some implementations described herein provide a system for evaluating an LLM-generated response to a user query. In some implementations, a system may obtain a user query and may generate a response to the user query based on a first prompt and using an LLM, with the first prompt causing the LLM to generate the response based on a first persona (e.g., an output producer persona). The system may then evaluate the response based on a second prompt and using the LLM, with the second prompt causing the LLM to evaluate the response based on a second (different) persona (e.g., a quality assurance persona). The system may then perform a response evaluation action based on a result of evaluating the response. Here, the use of the second persona enables the system to perform quality assurance of the LLM-generated response generated according to the first persona.

In this way, review of LLM-generated responses can be performed with improved consistency and with a reduced latency (e.g., as compared to manual review of LLM-generated responses). Further, the review of LLM-generated responses can be performed automatically (e.g., without human intervention) with improved correlation to human judgment (e.g., as compared to using reference-based or reference-free metrics). Additionally, the review of LLM-generated responses can be performed using a single LLM that is prompted to adopt different personas (e.g., rather than multiple different LLMs), which reduces cost and resource consumption associated with LLM model generation, training, and maintenance. Additional details are provided below.

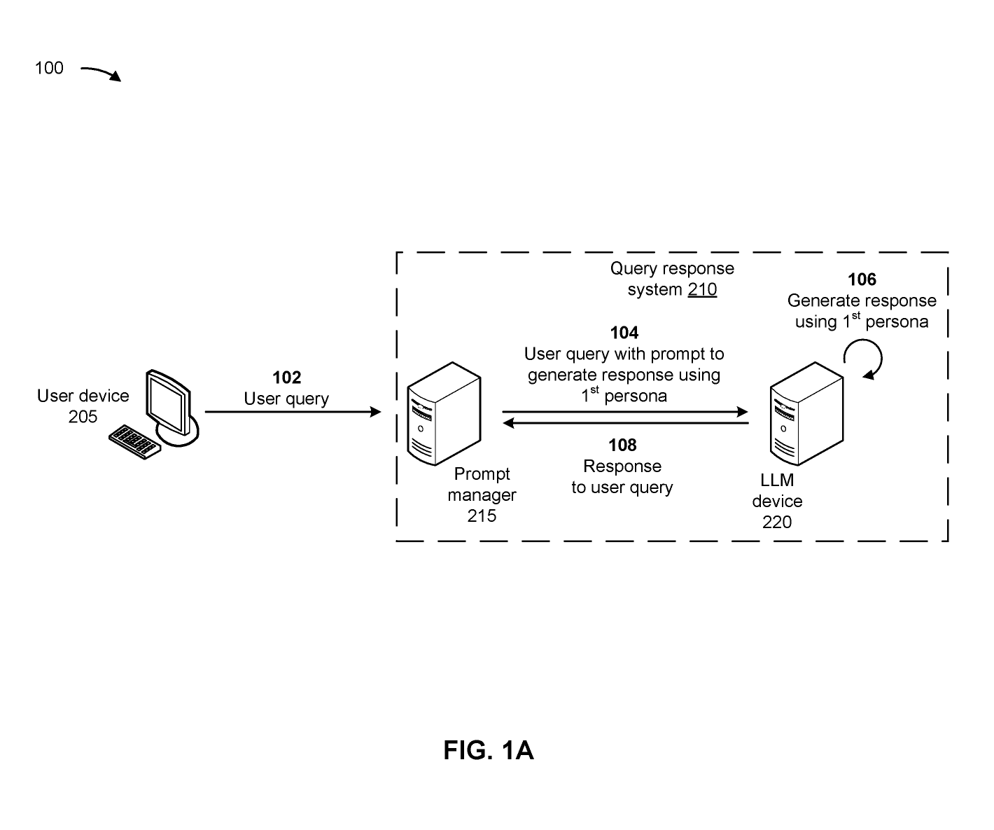

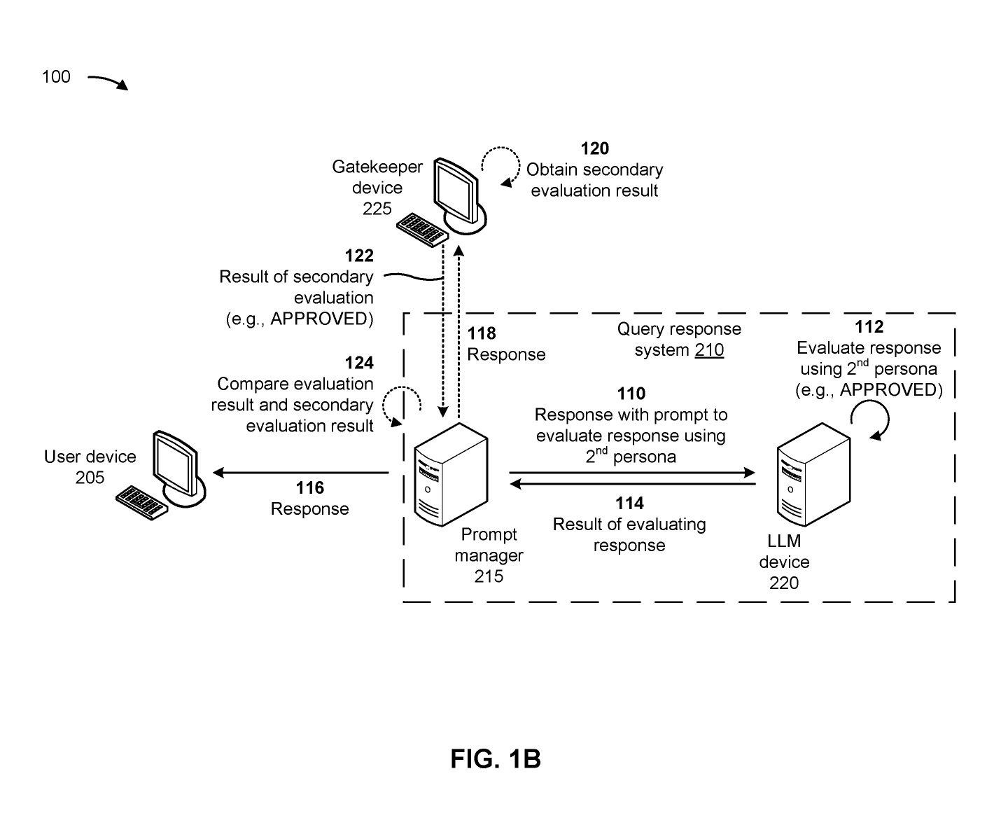

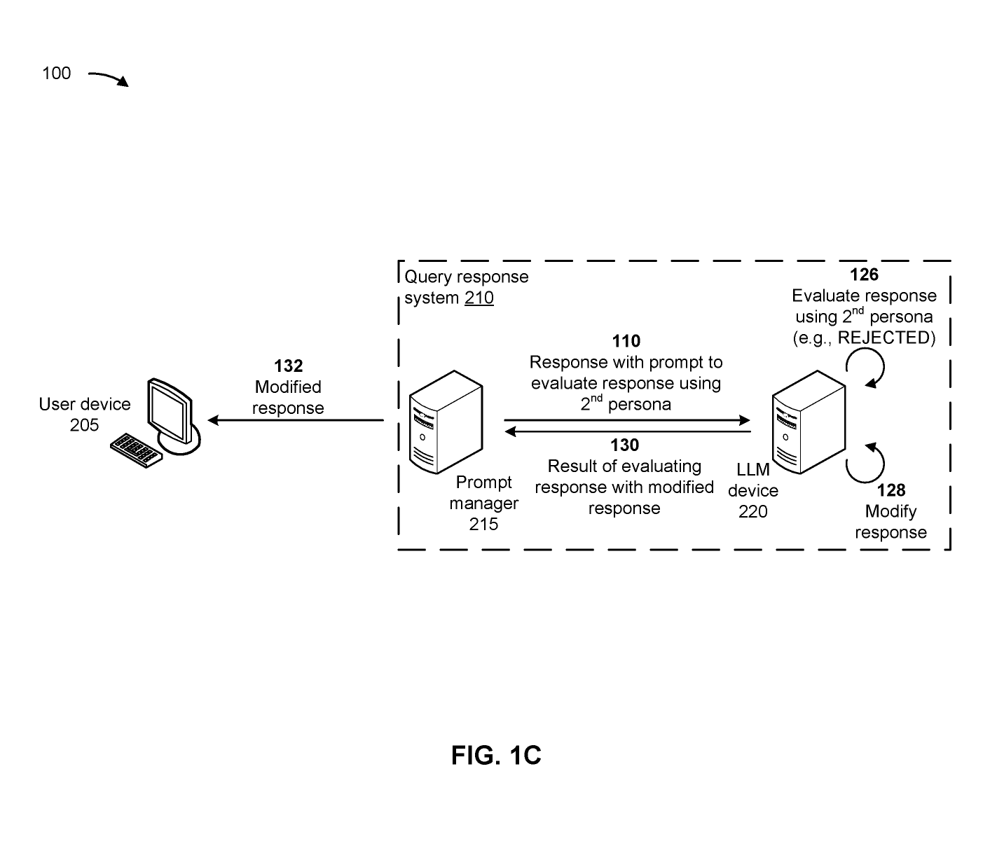

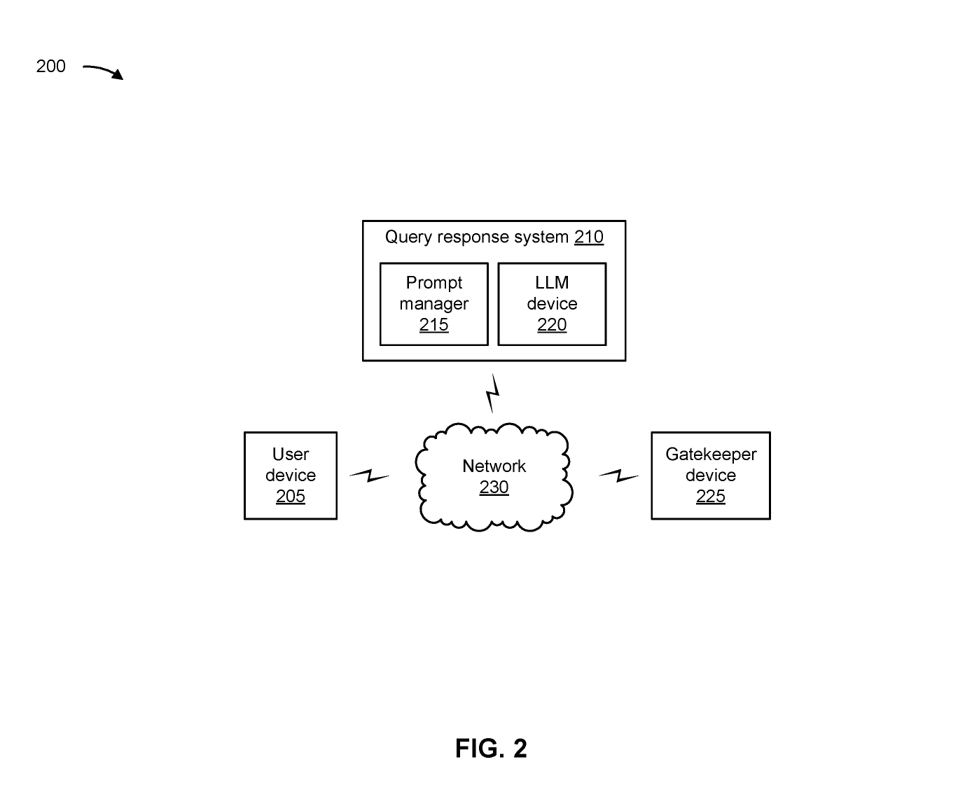

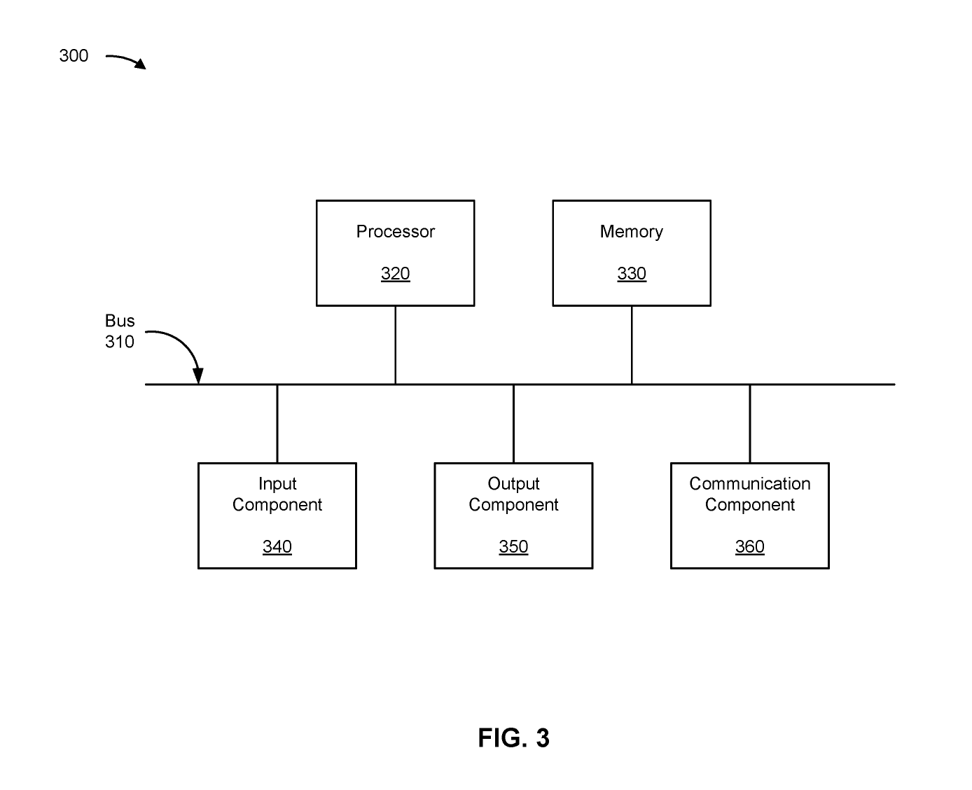

FIGS. 1A-1C are diagrams of an example 100 related to evaluating an LLM-generated response to a user query. As shown in FIGS. 1A-1C, example 100 includes a user device 205, a query response system 210 including a prompt manager 215 and an LLM device 220, and a gatekeeper device 225. These devices are described in more detail in connection with FIGS. 2 and 3.

As shown in FIG. 1A at reference 102, the query response system 210 may obtain a user query. For example, a user of the user device 205 may provide the user query via user input to the user device 205. The user device 205 may then provide the user query to the prompt manager 215 of the query response system 210. In some implementations, the user query is an input for which the query response system 210 is to generate a response (e.g., an input to which the user wishes to obtain a response from the query response system 210). The user query may include, for example, a question, a request for information, or another type of input based on which the user wishes to obtain a response.

As shown at reference 104, the prompt manager 215 may provide the user query and a first prompt to the LLM device 220 of the query response system 210. As used herein, “prompt” refers to information (e.g., text or an instruction) that defines a manner in which the LLM device 220 generates an output (e.g., a manner in which the LLM device 220 generates a response, a manner in which the LLM device 220 evaluates a response, or the like). More generally, a prompt is an input that instructs the LLM device 220 with respect to an expectation for an output of the LLM device 220.

In some implementations, a prompt may indicate or describe a persona based at least in part on which the LLM device 220 is to generate the output. As used herein, “persona” refers to a personality, character, or attribute that the LLM device 220 is to adopt with respect to generating an output. In general, the persona guides a manner in which the LLM device 220 communicates, responds, and expresses information. In some implementations, the persona may indicate a role-specific behavior that the LLM device 220 is to adopt when generating an output (e.g., generating a response, evaluating a response, or the like). In some implementations, the purpose of the role-specific behavior is to cause the LLM device 220 to adopt a specific role in association with generating the output. In some implementations, the persona may define one or more other attributes, such as a tone, a style, formality, or a specific knowledge area. In some implementations, the persona may indicate an expertise or knowledge focus that guides the output to be generated by the LLM device 220 (e.g., such that the LLM device 220 takes on the persona of an expert in a particular field).

In some implementations, the first prompt includes an indication that the LLM device 220 is to generate a response to the user query according to a first persona. In some implementations, the first persona is an output producer persona. As used herein, “output producer persona” refers to a persona associated with generating a response based on an input (e.g., a user query), rather than, for example, engaging in conversational or abstract dialogue. For example, the output producer persona may cause the LLM device 220 to focus on task execution (e.g., processing instructions and producing output) with precision and clarity (e.g., providing concise, objective, and result-oriented responses). Put another way, the output producer persona may cause the LLM device 220 to act in a pragmatic or utilitarian manner, aiming to generate a productive and useful response to the user query.

As shown at reference 106, the LLM device 220 may generate a response to the user query based on the first prompt and using an LLM. For example, the LLM device 220 may receive the user query and the first prompt and provide the user query and the first prompt as an input to an LLM configured on the LLM device 220. In some implementations, the first prompt causes the LLM device 220 to generate the response to the user query based on the first persona. That is, the prompt manager 215 may cause the LLM configured on the LLM device 220 to generate the response to the user query while adopting the first persona as indicated by the first prompt. For example, if the first prompt indicates that the LLM device 220 is to adopt an output producer persona, then the LLM device 220 may generate the response according to the output producer persona (e.g., the response may include an answer to a question or request provided in the user query). As shown at reference 108, the LLM device 220 may provide the response generated by the LLM of the LLM device 220 (herein referred to as an LLM-generated response) to the prompt manager 215.

In some implementations, the query response system 210 may evaluate the response, as described below. The query response system 210 may evaluate the response to, for example, determine whether the LLM-generated response includes inappropriate, irrelevant, or hallucinated information. That is, in some examples, the query response system 210 may provide quality assurance for the LLM-generated response.

In some implementations, the query response system 210 may evaluate the response based on a second prompt and using the LLM configured on the LLM device 220. For example, as shown in FIG. 1B at reference 110, the prompt manager 215 may provide the response and a second prompt to the LLM device 220. In some implementations, the second prompt includes an indication that the LLM device 220 is to generate a response to the user query according to the second persona. In some implementations, the second persona is a quality assurance persona. As used herein, “quality assurance persona” refers to a persona that causes the LLM to evaluate a response generated by the LLM to determine whether the response includes inappropriate, irrelevant, or hallucinated information. In some implementations, the quality assurance persona may mimic a perspective, expectation, or need of a quality assurance tester focused on evaluating reliability or usability of the LLM. In some implementations, the LLM device 220 may evaluate the response according to a self-reflection technique (e.g., input/output reflection, chain-of- thought, self-consistency, tree of thoughts, Reflexion, dialogue-enabled resolving agents (DERA), or the like).

As shown at reference 112, an output of the LLM device 220 may include a result of evaluating the response based on the second prompt and using the LLM. For example, the LLM device 220 may receive the response and the second prompt and provide the response and the second prompt as an input to the LLM configured on the LLM device 220. In some implementations, the second prompt causes the LLM device 220 to evaluate the response based on the second persona. That is, the prompt manager 215 may cause the LLM configured on the LLM device 220 to evaluate the response while adopting the second persona as indicated by the second prompt. For example, if the second prompt indicates that the LLM device 220 is to adopt a quality assurance persona, then the LLM device 220 may evaluate the response according to the quality assurance persona. In one such example, as shown in FIG. 1B, a result of the evaluation performed by the LLM device 220 may be that the response is approved (e.g., that the response does not include inappropriate, irrelevant, or hallucinated information). In another example (e.g., as illustrated in FIG. 1C described below), the result may be that the response is rejected (e.g., that the response includes inappropriate, irrelevant, or hallucinated information).

As shown at reference 114 of FIG. 1B, in an example in which the result is that the response is approved, the LLM device 220 may provide information associated with the result to the prompt manager 215.

In some implementations, the query response system 210 may perform a response evaluation action based on the result of evaluating the response. For example, with respect to the example shown in FIG. 1B in which the result of evaluating the response is that the response is approved, the query response system 210 (e.g., the prompt manager 215) may provide the (approved) response to the user query to the user device 205, as shown by reference 116.

In some implementations, the query response system 210 is configured to perform the evaluation based on a result of a comparison of the result of evaluating the response and a result of another evaluation of the response. For example, in some implementations, the query response system 210 may compare the result of evaluating the response provided by the LLM device 220 to a result of a secondary evaluation performed by the gatekeeper device 225. In such an implementation, as shown in FIG. 1B, the query response system 210 may provide the response to the gatekeeper device 225. As shown by reference 120, the gatekeeper device 225 may obtain a result of a secondary evaluation of the response. In some implementations, the secondary evaluation may be performed by another LLM (e.g., an LLM configured on the gatekeeper device 225). Additionally, or alternatively, the secondary evaluation may be performed manually (e.g., by a user of the gatekeeper device 225). As shown at reference 122, the gatekeeper device 225 may provide a result of the secondary evaluation (e.g., approval, rejection, or the like) to the query response system 210 (e.g., to the prompt manager 215).

In the example shown in FIG. 1B, the result of the secondary evaluation is an approval of the response. Here, as shown at reference 124, the prompt manager 215 may compare the result of the evaluation and the result of the secondary evaluation and may perform a response evaluation accordingly. For example, if the result of the evaluation as performed by the query response system 210 and the result of the secondary evaluation are approvals of the response, then the query response system 210 may provide the response to the user device 205 (e.g., as described with respect to reference 116). In another example, if the result of the evaluation as performed by the query response system 210 is an approval of the response and the result of the secondary evaluation is a rejection of the response, then the response evaluation may include, for example, an instruction for the LLM device 220 to modify the response or to generate another response (e.g., using a third prompt).

In some implementations, the response evaluation action may include modifying the response. For example, as shown in FIG. 1C at reference 126, the result of evaluating the response may be a denial of the response. In this example, as shown by reference 128, the LLM device 220 may modify the response using the LLM. In some implementations, the LLM device 220 may modify the response based on information associated with the result. For example, the LLM device 220 may modify the response to remove or modify inaccurate, irrelevant, or hallucinated information. As shown at reference 130, the LLM device 220 may then provide information associated with the result of evaluating the response (e.g., an indication that the response has been modified) and the modified response to the prompt manager 215. As shown at reference 132, the prompt manager 215 may then provide the modified response to the user device 205. In some implementations, the query response system 210 may evaluate the modified response prior to providing the modified response to the prompt manager 215, and may act accordingly (e.g., the LLM device 220 may further modify the response, as needed). In this way, the LLM device 220 may iteratively evaluate and modify the response so as to generate and provide an approved response to the prompt manager 215.

As indicated above, FIGS. 1A-1C are provided as an example. Other examples may differ from what is described with regard to FIGS. 1A-1C. For example, in some implementations, the query response system 210 may combine the techniques described with respect to FIG. 1B (e.g., comparison of an evaluation result with a secondary evaluation result) and FIG. 1C (e.g., modification of a response and evaluation of a modified response) in association with evaluating an LLM-generated response. As another example, although the use of a first persona and a second persona are described with respect to FIGS. 1A-1C, the techniques and apparatuses described herein can be applied to any number of personas (e.g., such that an output generated based on a first persona is evaluated based on multiple other personas. In one particular example, the LLM device 220 may generate a response based on a first persona, may fact-check the response based on a second persona, may edit the response for concision based on a third persona, may create a list of potential references based on a fourth persona, and so forth.

FIG. 2 is a diagram of an example environment 200 in which systems and/or methods described herein may be implemented. As shown in FIG. 2, environment 200 may include a user device 205, a query response system 210 including a prompt manager 215 and an LLM device 220, a gatekeeper device 225, and a network 230. Devices of environment 200 may interconnect via wired connections, wireless connections, or a combination of wired and wireless connections.

The user device 205 may include one or more devices capable of receiving, generating, storing, processing, and/or providing information related to evaluating an LLM-generated response to a user query, as described elsewhere herein. The user device 205 may include a communication device and/or a computing device. For example, the user device 205 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The query response system 210 may include one or more devices capable of receiving, generating, storing, processing, providing, and/or routing information related to evaluating an LLM-generated response to a user query, as described elsewhere herein. In some implementations, the query response system 210 includes the prompt manager 215 and the LLM device 220. In some implementations, the query response system 210 may include a communication device and/or a computing device. For example, the query response system 210 may include a server, such as an application server, a client server, a web server, a database server, a host server, a proxy server, a virtual server (e.g., executing on computing hardware), or a server in a cloud computing system. In some implementations, the query response system 210 may include computing hardware used in a cloud computing environment. In some implementations, the query response system 210 may be implemented on the user device 205.

The prompt manager 215 may include one or more devices capable of receiving, generating, storing, processing, providing, and/or routing information related to evaluating an LLM-generated response to a user query, as described elsewhere herein. The prompt manager 215 may include a communication device and/or a computing device. For example, the prompt manager 215 may include a server, such as an application server, a client server, a web server, a database server, a host server, a proxy server, a virtual server (e.g., executing on computing hardware), or a server in a cloud computing system. In some implementations, the prompt manager 215 may include computing hardware used in a cloud computing environment.

The LLM device 220 may include one or more devices capable of receiving, generating, storing, processing, providing, and/or routing information associated with evaluating an LLM-generated response to a user query, as described elsewhere herein. The LLM device 220 may include a communication device and/or a computing device. For example, the LLM device 220 may include a server, such as an application server, a client server, a web server, a database server, a host server, a proxy server, a virtual server (e.g., executing on computing hardware), or a server in a cloud computing system. In some implementations, the LLM device 220 may include computing hardware used in a cloud computing environment.

The gatekeeper device 225 may include one or more devices capable of receiving, generating, storing, processing, providing, and/or routing information related to evaluating an LLM-generated response to a user query, as described elsewhere herein. The gatekeeper device 225 may include a communication device and/or a computing device. For example, the gatekeeper device 225 may include a server, such as an application server, a client server, a web server, a database server, a host server, a proxy server, a virtual server (e.g., executing on computing hardware), or a server in a cloud computing system. In some implementations, the gatekeeper device 225 may include computing hardware used in a cloud computing environment.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with evaluating an LLM-generated response to a user query. The device 300 may correspond to the user device 205, the query response system 210, the prompt manager 215, the LLM device 220, and/or the gatekeeper device 225. In some implementations, the user device 205, the query response system 210, the prompt manager 215, the LLM device 220, and/or the gatekeeper device 225 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

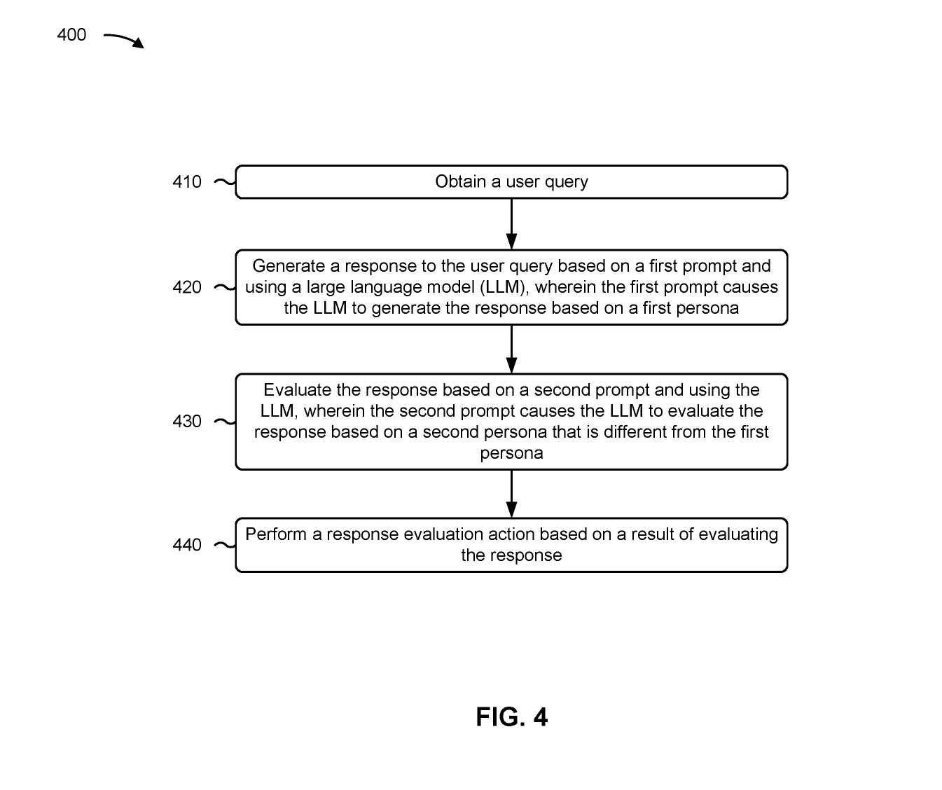

FIG. 4 is a flowchart of an example process 400 associated with evaluating an LLM-generated response to a user query. In some implementations, one or more process blocks of FIG. 4 may be performed by the query response system 210 (e.g., the prompt manager 215 and/or the LLM device 220). In some implementations, one or more process blocks of FIG. 4 may be performed by another device or a group of devices separate from or including the query response system 210, such as the user device 205 and/or the gatekeep device 225. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining a user query (block 410). For example, the query response system 210 (e.g., using processor 320 and/or memory 330) may obtain a user query, as described above in connection with reference 102 of FIG. 1A. As an example, the query response system 210 may obtain a user query including a question to which a user wishes to receive a response.

As further shown in FIG. 4, process 400 may include generating a response to the user query using an LLM, wherein the LLM generates the response based on a first persona (block 420). For example, the query response system 210 (e.g., using processor 320 and/or memory 330) may generate a response to the user query using an LLM, wherein the LLM generates the response based on a first persona, as described above in connection with reference 106 of FIG. 1A. As an example, the first prompt may indicate that the query response system 210 (e.g., the LLM configured on the LLM device 220) is to adopt an output producer persona, and the query response system 210 may generate the response to the user query according to the output producer persona (e.g., the response may include an answer to the question indicated in the user query).

As further shown in FIG. 4, process 400 may include evaluating the response using the LLM, wherein the LLM evaluates the response based on a second persona that is different from the first persona (block 430). For example, the query response system 210 (e.g., using processor 320 and/or memory 330) may evaluate the response using the LLM, wherein the LLM evaluates the response based on a second persona that is different from the first persona, as described above in connection with reference 112 of FIG. 1B. As an example, the second prompt may indicate that the query response system 210 is to adopt a quality assurance persona, and the query response system 210 may evaluate the response according to the quality assurance persona.

As further shown in FIG. 4, process 400 may include performing a response evaluation action based on a result of evaluating the response (block 440). For example, the query response system 210 (e.g., using processor 320 and/or memory 330) may perform a response evaluation action based on a result of evaluating the response, as described above in connection with FIGS. 1B and 1C. As an example, a result of the evaluation performed by the query response system 210 may be that the response is approved (e.g., that the response does not include inappropriate, irrelevant, or hallucinated information). Here, the response evaluation action may include providing the (approved) response to the user device 205.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for evaluating a large language model (LLM) generated response to a user query, the system comprising:
one or more memories; and
one or more processors, communicatively coupled to the one or more memories, configured to:
obtain the user query;
generate a response to the user query based on a first prompt and using an LLM, wherein the first prompt causes the LLM to generate the response based on a first persona;
evaluate the response based on a second prompt and using the LLM, wherein the second prompt causes the LLM to evaluate the response based on a second persona that is different from the first persona; and
perform a response evaluation action based on a result of evaluating the response.

2. The system of claim 1, wherein the result of the evaluation includes an approval of the response or a denial of the response.

3. The system of claim 1, wherein the one or more processors, to perform the response evaluation action, are configured to provide the response based on the result of evaluating the response.

4. The system of claim 1, wherein the one or more processors, to perform the response evaluation action, are configured to:
modify the response using the LLM, and based at least in part on the result of evaluating the response, generate a modified response; and
provide the modified response.

5. The system of claim 4, wherein the one or more processors are further configured to evaluate the modified response prior to providing the modified response.

6. The system of claim 1, wherein the one or more processors are configured to evaluate the response according to a self-reflection technique.

7. The system of claim 1, wherein the first persona is an output producer persona.

8. The system of claim 1, wherein the first persona is a quality assurance persona.

9. The system of claim 1, wherein the one or more processors, to perform the response evaluation action, are configured to perform the evaluation based on a result of a comparison of the result of evaluating the response and a result of another evaluation of the response.

10. A method for evaluating a large language model (LLM) generated response to a user query, comprising:
obtaining, by a system, a user query;
generating, by the system, a response to the user query using an LLM, wherein the LLM generates the response based on a first persona;
evaluating, by the system, the response using the LLM, wherein the LLM evaluates the response based on a second persona that is different from the first persona; and
performing, by the system, a response evaluation action based on a result of evaluating the response.

11. The method of claim 10, wherein the result of the evaluation includes an approval of the response or a denial of the response.

12. The method of claim 10, wherein performing the response evaluation action comprises providing the response based on the result of evaluating the response.

13. The method of claim 10, wherein performing the response evaluation action comprises:
modifying the response using the LLM, and based at least in part on the result of evaluating the response, to generate a modified response; and
providing the modified response.

14. The method of claim 13, further comprising evaluating the modified response prior to providing the modified response.

15. The method of claim 10, wherein the response is evaluated according to a self-reflection technique.

16. The method of claim 10, wherein the first persona is an output producer persona.

17. The method of claim 10, wherein the first persona is a quality assurance persona.

18. The method of claim 10, wherein performing the response evaluation action comprises performing the evaluation based on a result of a comparison of the result of evaluating the response and a result of another evaluation of the response.

19. A non-transitory computer-readable medium storing a set of instructions, the set of instructions comprising:
one or more instructions that, when executed by one or more processors of a system, cause the system to:
obtain a query provided via user input;
obtain, as a first output of a large language model (LLM), a response to the query, wherein the LLM is instructed to generate the first output based on adopting a first persona;
obtain, as a second output of the LLM, a result associated with an evaluation of the response, wherein the LLM is instructed to evaluate the response based on adopting a second persona that is different from the first persona; and
perform a response evaluation action based on the result of the evaluation of the response.

20. The non-transitory computer-readable medium of claim 19, wherein the one or more instructions, that cause the system to perform the response evaluation action, cause the system to:
modify the response using the LLM, and based at least in part on the result of evaluating the response, to generate a modified response; and
provide the modified response.
